(19) United States
(12) Patent Application Publication
(10) Pub. No.: US 2011/0296140 A1
(43) Pub. Date: Dec. 1, 2011

(54) RISC processor register expansion method

(75) Inventors: Rong-Guey Chang, Chiayi County (TW); Yuan-Shin Hwang, Taipei County (TW); Hong-Sheng Lin, Hsinchu County (TW)

(73) Assignee: NATIONAL CHUNG CHENG UNIVERSITY, Chia-Yi (TW)

(21) Appl. No.: 12/801,131

(22) Filed: May 25, 2010

(51) Int. Cl. G06F 15/76; G06F 9/06

(52) U.S. Cl. 712/41; 712/E09.003

(57) ABSTRACT

A RISC processor register expansion method is disclosed to include the steps of: a) designing an instruction format having multiple register fields to have the total bits consumed by the register fields to be designed into two bits combinations respectively corresponding to two register banks, wherein the first bits combination has 8 bits of which the value of the 1^{st}˜7^{th} bits is adapted to designate the location (0-127) of the first register field in one of the two register banks and the value of the 8^{th} bit is adapted to designate which one of the two register banks the first register field is to be allocated, and the second bits combination has at least 2 bits; b) defining an operation instruction without exchangeability to be an inverse operation instruction; and c) designing a register allocation algorithm to pick up one respective operand variable from each of the two register banks and to join the two operand variables into a node and using the relationship between nodes to run computation and to determine whether or not to change an instruction into an inverse operation instruction.

### BACKGROUND OF THE INVENTION

1. Field of the Invention

The present invention relates to processor registers and more particularly, to a method of expanding the capacity of RISC processor registers.

2. Description of the Related Art

In RISC processor registers, the register fields of the normal instruction format employs direct encoding, therefore the encoding space for the register fields of the normal instruction format directly affects the amount of the architectural registers. Increasing the encoding space for the register fields can improves the amount of the architectural registers, however the whole code size will be relatively increased. Further, increasing the encoding space for the register fields means an increase of the length of instructions. These instructions will become more complicated in the pipeline decode stage, increasing power consumption of the processor. To embedded processors that emphasize the factors of power consumption and storage space, the aforesaid result is contrary to what is expected.

The major processors in the market, such as MIPS, ARM, Alpha, THUMB, X86, UltraSPARC and Power, commonly have 8˜32 architectural registers, i.e., the encoding space of the register fields is about 3˜5 bits. This arrangement limits the amount of the usable architectural registers, causing a bottleneck in program execution efficiency improvement.

Current researches and techniques to improve the usable amount of architectural registers are focused on adding hardware. However, adding hardware brings certain side effects, such as increasing the hardware cost, complicating the hardware design, limiting the applicability to specific platforms and lowering the flexibility in use.

In conclusion, the known techniques have the drawbacks as follows:
1. Conventional instruction formats restrict the use of architectural registers.
2. Some researches and techniques are suitable for specific platforms, limiting the applicability and the flexibility in use.
3. It is difficult to improve the program execution efficiency while controlling the instruction code size.

### SUMMARY OF THE INVENTION

The present invention has been accomplished under the circumstances in view. It is the main object of the present invention to provide a method of expanding the capacity of RISC processor registers, which breaks through instruction format limits, effectively improves the use of architectural registers on different platforms, and greatly enhances program execution efficiency.

To achieve this and other objects of the present invention, a RISC processor register expansion method comprises the steps of: a) designing an instruction format having multiple register fields to have the total bits consumed by the register fields to be designed into two bits combinations respectively corresponding to two register banks, wherein the first bits combination has 8 bits of which the value of the 1^{st}˜7^{th} bits is adapted to designate the location (0-127) of the first register field in one of the two register banks and the value of the 8^{th} bit is adapted to designate which one of the two register banks the first register field is to be allocated, and the second bits combination has at least 2 bits; b) defining an operation instruction without exchangeability to be an inverse operation instruction wherein the inverse operation instruction is to swap the operand variables in the two register banks in the same position prior to computing, eliminating the problem of a different operation result due to the order of the register banks on which the operand variables are allocated; and c) designing a register allocation algorithm to pick up one respective operand variable from each of the two register banks and to join the two operand variables into a node. The register allocation algorithm comprises the steps of: c1) checking the relationship between the two operands in the current node and the operands of the other nodes to be the same or partially different, and then proceeding to step c2) when partially different, or step c3) when the same, and then searching the storable position in the two register banks when neither the aforesaid relationship condition exists; c2) searching for the other nodes that have the operands therein partially same as the two operands of the current node, and then checking the operands of the searched nodes that are different from the operands of the current node to be empty or to have another different relationship and then using the searched node and transferring the operands from the current node to the searched node and then deleting the current node; c3) searching for the other nodes that have the operands therein to be same as the two operands of the current node and then deleting the current node when a node that has the operands therein to be same as the two operands of the current node is found; and c4) determining whether or not to change the operation instruction into an inverse operation instruction subject to the nature of the operation instruction.

Thus, this RISC processor register expansion method breaks through instruction format limits, raises the number of bits and effectively enhances the use of architectural registers. Further, this RISC processor register expansion method is applicable to different platforms and greatly enhances the program execution efficiency without increasing the instruction code size.

### BRIEF DESCRIPTION OF THE DRAWINGS

FIG. 1 is a schematic diagram of an instruction format according to a first embodiment of the present invention.

FIG. 2 is a schematic drawing of the first embodiment of the present invention, showing an operation status of an operation instruction having exchangeability.

FIG. 3 is a schematic drawing of the first embodiment of the present invention, showing an operation status of an operation instruction without exchangeability.

FIG. 4 is a schematic drawing of the first embodiment of the present invention, showing the status of the D-nodes.

FIG. 5 is a schematic drawing of the first embodiment of the present invention, showing the status of the G-nodes.

FIG. 6 is a schematic drawing of the first embodiment of the present invention, showing the allocation of the registers and the related operation subject the NDG.

FIG. 7 is a schematic diagram of an instruction format according to a second embodiment of the present invention.

FIG. 8 is a schematic drawing of the second embodiment of the present invention, showing the allocation of the registers and the related operation subject the NDG.

### DETAILED DESCRIPTION OF THE INVENTION

Other and further advantages, benefits and features of the present invention will be fully understood by reference to the following specification in conjunction with the accompanying drawings.

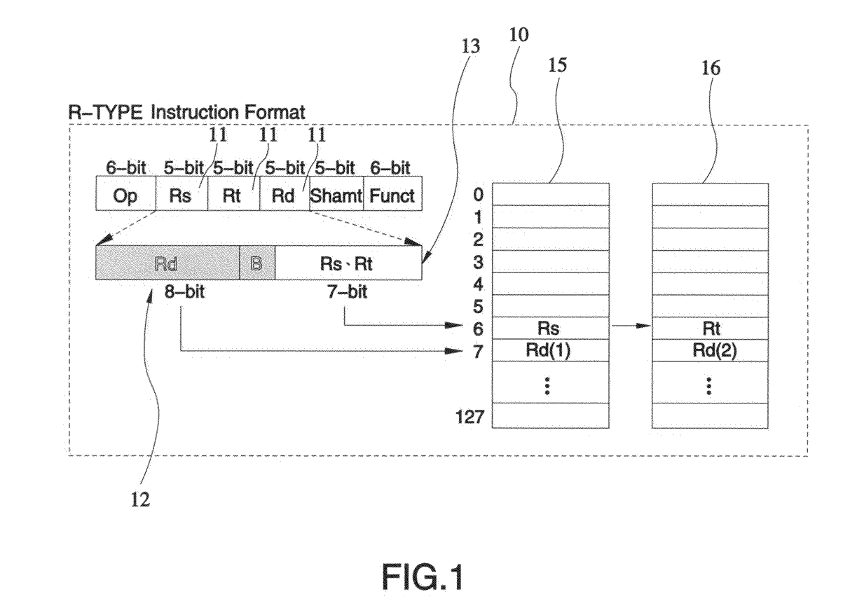

Referring to FIG. 1, a method of expanding the capacity of RISC processor registers in accordance with a first embodiment of the present invention includes the steps of:

a) As shown in FIG. 1, design an instruction format (10) for the RISC processor wherein the instruction format (10) is a R-Type instruction format having three register fields (11) corresponding to Rd operand (the register destination operand), Rs operand (the first register source operand) and Rt operand (the second register source operand). These register fields (11) correspond to respective real registers. These register fields (11) consume totally 15 bits that are designed into two bits combinations (12) and (13). The instruction format (10) corresponds to two register banks (15) and (16). The first bits combination (12) has 8 bits of which the value of the 1^{st}˜7^{th} bits is adapted to designate the location (0-127) of the first register field Rd in one of the two register banks and the value of the 8^{th} bit is adapted to designate which one of the two register banks (15) and (16) the first register field Rd is to be allocated, and the second bits combination (13) has 7 bits adapted to designate the position (0˜127) of the register field Rs and the register field Rt in the register bank, wherein the register field Rs is located on the first register bank (15) and the register field Rt is located on the second register bank (16). The register fields (11) are used for storing the respective operand variables.

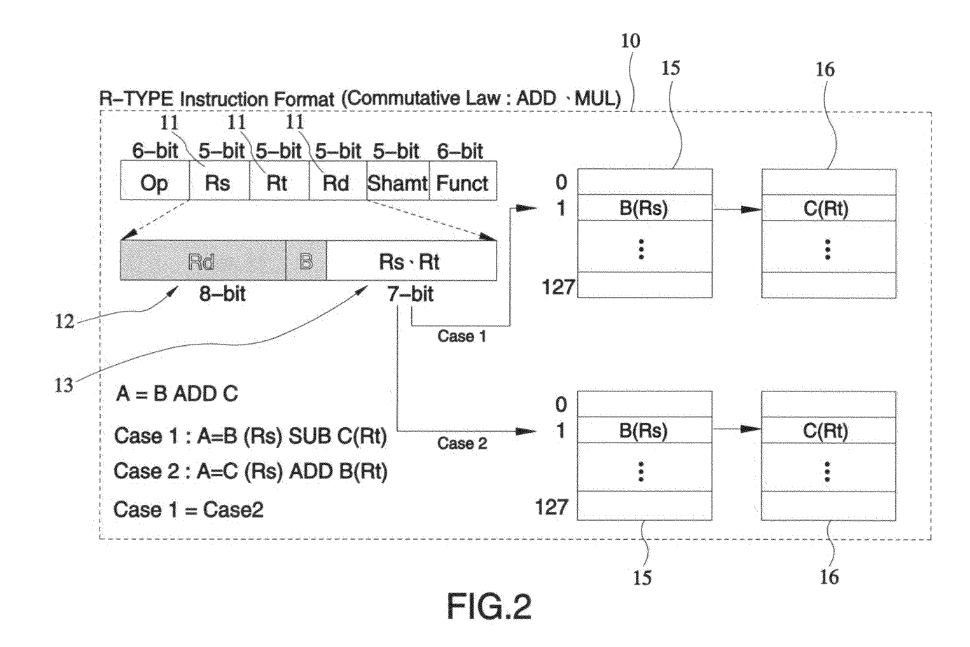

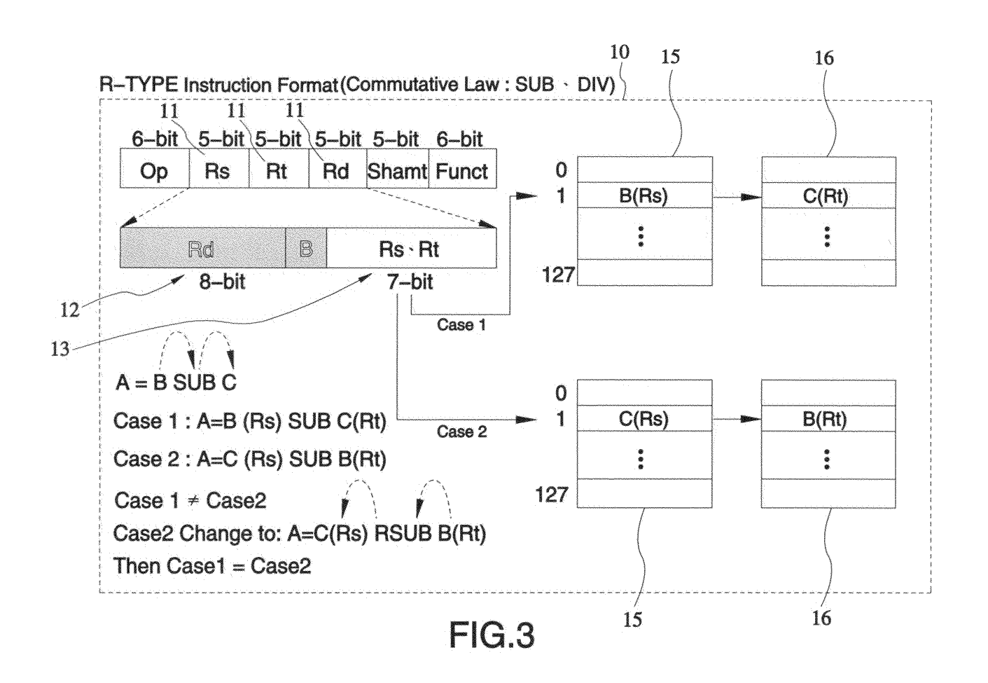

b) Define operation instructions without exchangeability to be inverse operation instructions. To an operation instruction having an exchange characteristic (for example, the add instruction), the order of the register bank (15) or (16) on which the operand variable is located does not affect the final execution result (see FIG. 2). To a non-exchange operation instruction (for example, the sub instruction), the order of the register (15) or (16) on which the operand variable is located does will affect the final execution result (see FIG. 3). Therefore, the inverse operation instruction is to swap the operand variables in the two register banks (15) and (16) in the same position prior to computing, eliminating the problem of a different operation result due to the order of the register banks (15) and (16) on which the operand variables are allocated.

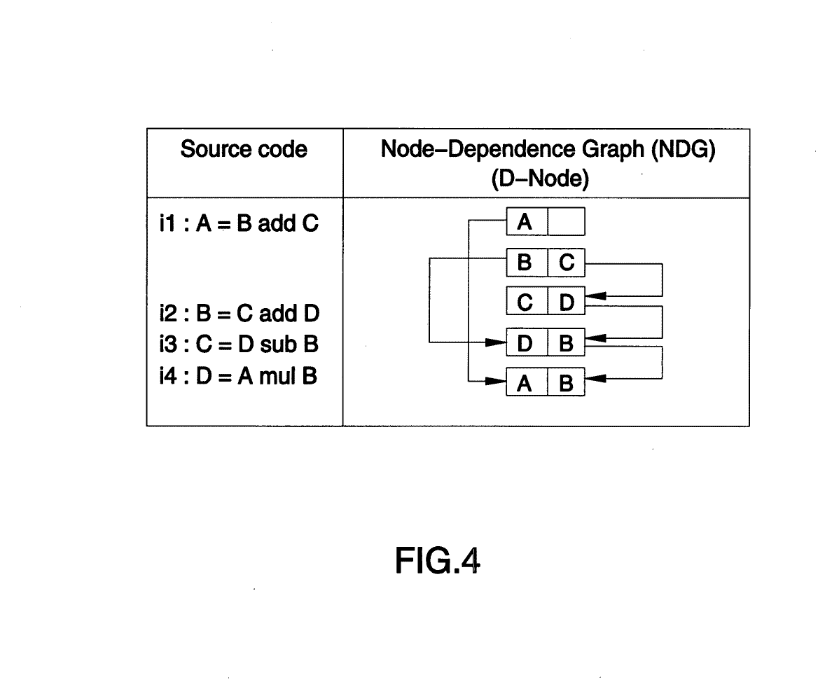

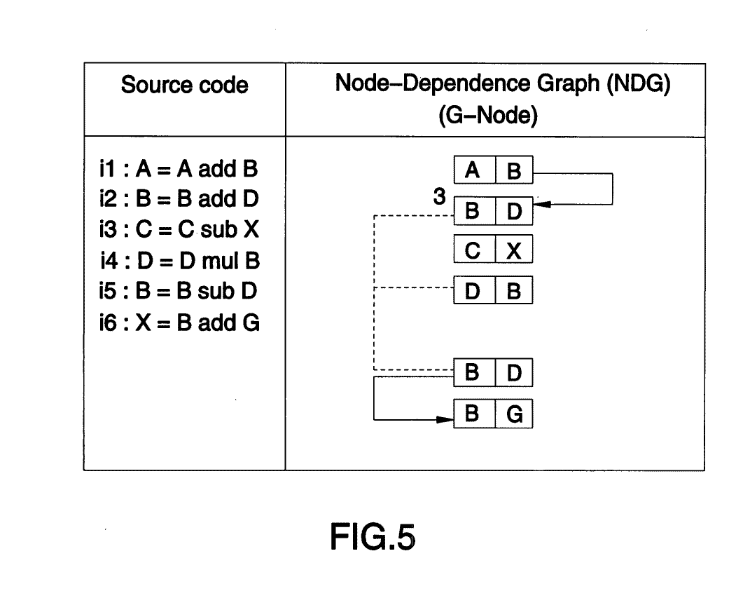

c) As shown in FIG. 4 and FIG. 5, design a register allocation algorithm to pick up one respective operand variable from each of the two register banks (15) and (16) and to join the two operand variables into a node, and then to define respective nodes corresponding to different locations, and then to constitute a NDG (Node-Dependence Graph) with the nodes thus defined. In the R-Type instruction format (10), if the operand variable in one register field, for example, the register field Rd, does not exist in the NDG, add to the instruction format one new node that exists only in the operand variable. Except this condition, the other nodes are composed of the operand variables that exist in the register fields Rs and Rt. Therefore, two operand variables exist in one ordinary node. The left and right positions of the two operand variables in the respective node are regarded as the order of their allocation in the register banks (15) and (16), where the operand variable at the left side is regarded to be stored in the first register bank (15); the operand variable at the right side is regarded to be stored in the second register bank (16). Thereafter, classify the nodes, subject to their relationship, into D-nodes that are partially different as shown in FIG. 4, and G-nodes that have the same relationship as shown in FIG. 5. In D-nodes, the two operand variables of one node are partially different from that of the other nodes. In G-nodes, the two operand variables of one node are same as that of the other nodes.

Further, to every D-node, it is necessary to find the next node that uses its operand variables and then to draw a real line and an arrow to denote this dependent relationship; to every G-node, use an imaginary line to indicate the relationship and then calculate the weighted value of the same relationship and mark the weighted value on the first G-node, and then find whether or not the first G-node and the last G-node are partially dependent to the other D-nodes, and then draw a real line and an arrow to denote the partially dependent relationship, if any. The relationship of the aforesaid real line, imaginary line and arrow are shown in FIGS. 4 and 5.

The aforesaid register allocation algorithm includes the steps of:

c1) Check the relationship between the two operand variables of the current node and the operand variables of the other nodes to be of the same relationship (G-node) or partially different (D-node), and then proceed to step c2) if partially different, or step c3) if the same. If without any of the aforesaid relationships (for example, completely different), find a storable location from the two register banks (15) and (16).

c2) Based on the two operands in the current node, search the other D-nodes of which the operand variables are partially same as the two operands of the current node, and then check whether or not the operand variables of the searched D-node that are different from the current node are empty or have any other relationship, if the searched D-node is empty or have any other relationship, use the searched node and transfer the operand variables from the current node to the searched node when positive, and then delete the current node after transfer of the operand variables.

c3) Search for the other G-nodes that have the operands therein to be same as the two operands of the current node, and then deleting the current node when a node that has the operands therein to be same as the two operands of the current node is found.

c4) Determine, subject to the nature of the operation instruction, whether or not to change the instruction into an inverse operation instruction.

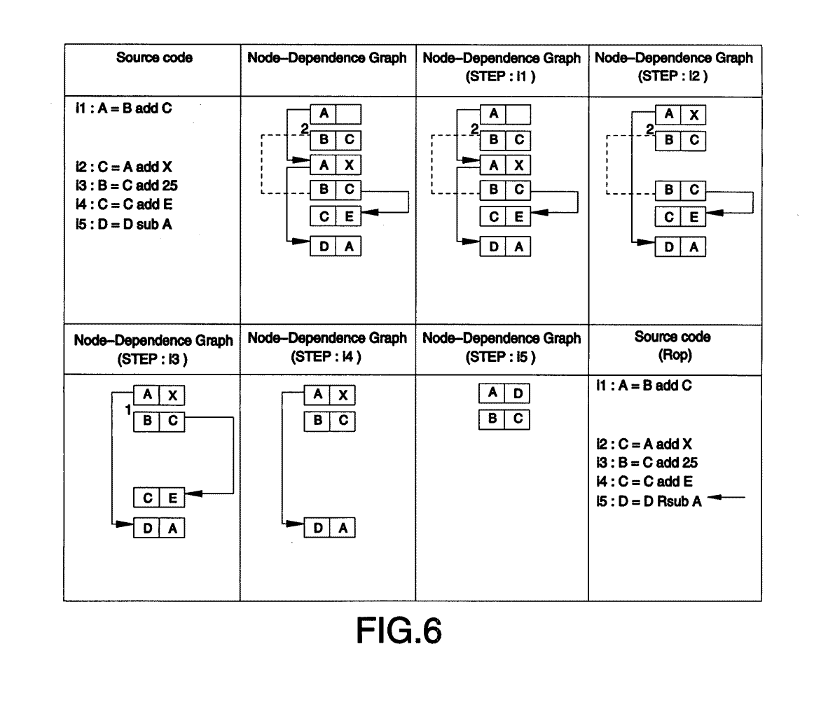

FIG. 6 explains how to use the NDG to allocate registers and also explains when to use the inverse operation instruction.

Directly allocate the operand variables to the assigned register banks (15) and (16) when executing step i1 after establishment of the NDG.

When executing step i2, due to the fact that A in D-node has a partially dependent relationship, check the last node that used A to see if the location for the right side operand variable is empty or it does not have a partially dependent relationship. When it meets the aforesaid condition, transfer X to the location of this node for the right side operand variable when it meets the aforesaid condition, and then delete the dependent real line and arrow and the original node from the NDG. Further, it is necessary to check whether or not to change the operation into an inverse operation instruction.

When executing step i3, due to all the nodes belong to G-nodes, it is not necessary to make any transfer. During this step, it simply needs to check whether or not the operation is exchangeable and the locations of the operand variables of the G-nodes in the register banks (15) and (16) are same. Based on the aforesaid conditions, determine whether or not to change the instruction into an inverse operation instruction. Because the operation of this step i3 is an add operation having exchangeability, it is not necessary to change the operation into an inverse operation instruction. It simply needs to deduct 1 from the weighted value of the G-node and to delete the imaginary line relationship and the node produced during step i3. At this time, the weighted value of the G-node which is deducted from that of the last one has become 1, and therefore the G-node is converted into a D-node to facilitate further operation.

When executing step i4, search the last node which used the operand variable C subject to the partially dependent characteristic of the D-node. At this time, check whether or not the left side operand variable location of this node is empty or it does not have the partially dependent relationship. When it meets the aforesaid condition, transfer the operand variable E to the original location for the operand variable B and then delete the real line and arrow head and the original node from the NDG. Further, it also needs to check whether or not to convert this operation into an inverse operation instruction.

When executing step i5, search the last node which used the operand variable A subject to the partially dependent characteristic of the D-node. At this time, check whether or not the right side operand variable location of this node is empty or if the right side operand variable location of this node does not have the partially dependent relationship. When it meets the aforesaid condition, transfer the operand variable D to the original location for the operand variable X and then delete the real line and arrow head and the original node from the NDG. Further, it also needs to check whether or not to convert this operation into an inverse operation instruction. We discovered that the operation of step i5 is a deduction operation without exchangeability and we also discovered the locations of the operand variables of the node in the register banks (15) and (16) and the related instruction. Therefore, the operation instruction of this step i5 must be converted into an inverse operation instruction Rsub.

Subject to the design of the aforesaid instruction format (10) and the definition of the inverse operation instruction and the register allocation algorithm, the allocation of the original registers is re-designed without changing the real register structure, enabling the number of registers to be increased from 3˜5 bits (i.e., 8˜32 registers) to 7 bits (128 registers). Thus, this method effectively achieves the desired register expansion effect. Through the explanation of FIG. 6, the execution of the whole NDG through nodes is fully explained and therefore the invention is fully understood.

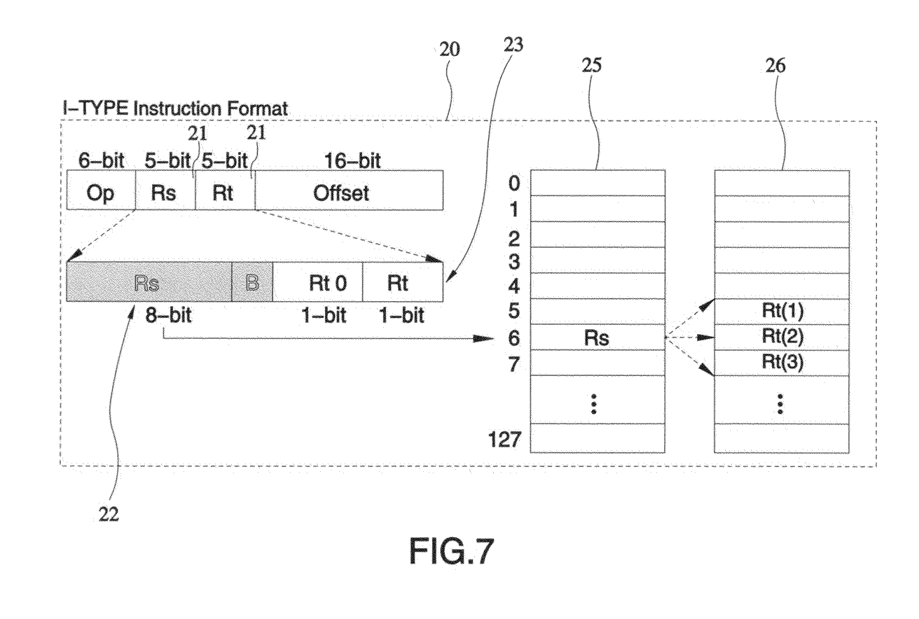

FIG. 7 illustrates a method of expanding the capacity of RISC processor registers in accordance with a second embodiment of the present invention. This second embodiment is substantially similar to the aforesaid first embodiment with the exception that this second embodiment is to design an I-Type instruction format (20) for the RISC processor.

As shown in FIG. 7, during step a), the instruction format is an I-type instruction format (20) having two register fields (21) corresponding to Rs operand (the first register source operand) and Rt operand (the second register source operand). The register fields (21) correspond to respective real registers. These register fields (w1) consume totally 10 bits that are designed into two bits combinations (22) and (23). The instruction format (10) corresponds to two register banks (25) and (26). The first bits combination (22) has 8 bits of which the value of the 1^{st}˜7^{th} bits is adapted to designate the location (0-127) of the first register field Rs in one of the two register banks and the value of the 8^{th} bit is adapted to designate which one of the two register banks (25) and (26) the first register field Rs is to be allocated, and the second bits combination (23) has 2 bits, wherein the first bit (Rt O) is adapted to designate the displacement direction of the register field Rt relative to the register field Rs; the second bit (Rt) is adapted to designate the amount of displacement of the register field Rt.

The relationship between the register field Rs and the register field Rt is explained hereinafter with reference to FIG. 7 again. In FIG. 7, the register field Rs is located on the position 6 (0000110) in the first register bank (25), thus the position of the register field Rt can be one of the following three conditions:
(1) The second bit of the second bits combination (Rt)=0, thus the position of the register field Rt is same as the position of the register field Rs in the register bank (25) or (26), however the register field Rt is allocated in a different register bank (25) or (26), for example, Rt(2) in FIG. 7.
(2) The second bit of the second bits combination (Rt)=1 and the first bit (Rt O)=0, thus the position of the register field Rt is to deduct 1 from the position of the register field Rs, for example, Rt(1) in FIG. 7.
(3) The second bit of the second bits combination (Rt)=1 and the first bit (Rt O)=1, thus, the position of the register field Rt is to add 1 to the position of the register field Rs, for example, Rt(3) in FIG. 7.

The other steps of this second embodiment are same as that of the aforesaid first embodiment, and therefore no further detailed description in this regard is necessary.

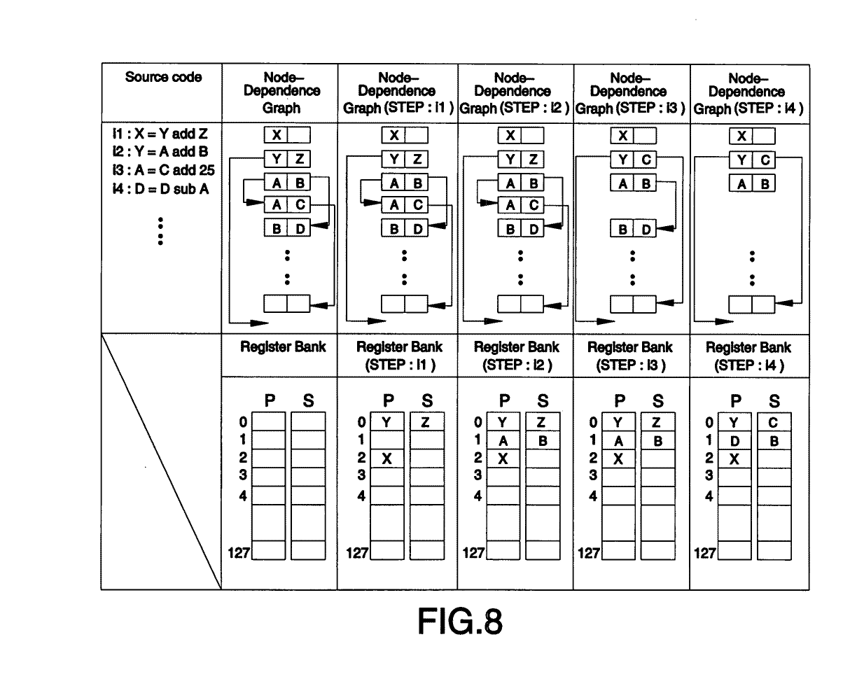

FIG. 8 explains how the NDG is used in the I-Type instruction format for register allocation and when the inverse operation instruction is necessary. In this example, we assumed the positions of the nodes during every step when allocating the registers, as shown in the register banks (25) and (26).

When executing step i1 and step i2 after establishment of the NDG, allocate the position of every node in the register bank (25) or (26) subject to the NDG.

When executing step i3, search the last node that used the operand variable A subject to the partially dependent characteristic of the D-node. At this time, the partially dependent relationship of the right side operand variable B of this node is discovered, i.e., there is another instruction going to use this operand variable B, and therefore it is not to be substituted. So, the second best is to check the position in the register bank (25) or (26) in front of the operand variable B and the position in the register bank (25) or (26) next to the operand variable B to be empty or to have a partially dependent relationship. If the position in front of or next to the operand variable B is empty or does not have a partially dependent relationship, use one of the positions for the transfer of the operand variable C during step i3. In this example, we found that the position 0 in the second register bank (25) or (26) and the position 2 in the register bank (25) or (26) are usable, and therefore the position 0 in the second register bank (25) or (26) is used for the transfer of the operand variable C. Thereafter, modify the relationship of the nodes in the NDG relative to the operand variable C.

From the description of the aforesaid two embodiments, the invention achieves the effects of: breaking through instruction format limits, raising the number of bits and effectively enhancing the use of architectural registers. Further, the invention is applicable to different platforms and greatly enhances the program execution efficiency without increasing the instruction code size.

What is claimed is:

1. A RISC processor register expansion method, comprising the steps of:
a) designing an instruction format having multiple register fields to have the total bits consumed by the register fields to be designed into two bits combinations respectively corresponding to two register banks, wherein the first bits combination has 8 bits of which the value of the 1^{st}˜7^{th} bits is adapted to designate the location (0-127) of the first register field in one of the two register banks and the value of the 8^{th} bit is adapted to designate which one of the two register banks the first register field is to be allocated, and the second bits combination has at least 2 bits;
b) defining an operation instruction without exchangeability to be an inverse operation instruction wherein the inverse operation instruction is to swap the operand variables in the two register banks in the same position prior to computing, eliminating the problem of a different operation result due to the order of the register banks on which the operand variables are allocated;
c) designing a register allocation algorithm to pick up one respective operand variable from each of the two register banks and to join the two operand variables into a node, the register allocation algorithm comprising the steps of:
c1) checking the relationship between the two operands in the current node and the operands of the other nodes to be the same or partially different, and then proceeding to step c2) when partially different, or step c3) when the same, and then searching the storable position in the two register banks when neither the aforesaid relationship condition exists;
c2) searching for the other nodes that have the operands therein partially same as the two operands of the current node, and then checking the operands of the searched nodes that are different from the operands of the current node to be empty or to have another different relationship and then using the searched node and transferring the operands from the current node to the searched node and then deleting the current node;
c3) searching for the other nodes that have the operands therein to be same as the two operands of the current node and then deleting the current node when a node that has the operands therein to be same as the two operands of the current node is found; and
c4) determining whether or not to change the operation instruction into an inverse operation instruction subject to the nature of the operation instruction.

2. The RISC processor register expansion method, wherein the instruction format designed during step a) is a R-Type instruction format having three register fields corresponding to Rd operand, Rs operand and Rt operand, the register fields consuming totally 15 bits that are designed into two bits combinations, the first operand being the Rd operand; said second bits combination has 7 bits adapted to designate the position (0˜127) of the register field Rs and the register field Rt in the register bank, wherein the register field Rs is located on the first register bank and the register field Rt is located on the second register bank.

3. The RISC processor register expansion method, wherein the instruction format designed during step a) is an I-Type instruction format having two register fields corresponding to Rs operand and Rt operand, the register fields consuming totally 10 bits that are designed into two bits combinations, the first operand being the Rs operand; said second bits combination has 2 bits, the first bit of said second bits combination being adapted to designate the direction of displacement of the operand Rt relative to the operand Rs, the second bit of said second bits combination being adapted to designate the amount of displacement of the operand Rt.

4. The RISC processor register expansion method as claimed in claim 1, wherein the left and right positions of the two operands in the node are regarded as the order of their allocation in the two register banks.
